(19) United States
(12) Patent Application Publication
(10) Pub. No.: US 2014/0101280 A1
(43) Pub. Date: Apr. 10, 2014

(54) GENERIC SERIALIZER FRAMEWORK

(71) Applicant: Olaf Schmidt, Walldorf (DE)

(72) Inventor: Olaf Schmidt, Walldorf (DE)

(21) Appl. No.: 13/645,939

(22) Filed: Oct. 5, 2012

(51) Int. Cl. G06F 15/16

(52) U.S. Cl. 709/217

(57) ABSTRACT

According to some embodiments, a method and apparatus are provided to receive a HTTP request and parse the HTTP request to determine a desired format. An instantiation of a serializer associated with the desired format is created.

### BACKGROUND

Unlike conventional database management systems which employ a disk-based storage mechanism (e.g., a magnetic disk or an optical disc), an in-memory database is a database management system that primarily relies on main memory for computer data storage. In-memory databases are faster than disk-based databases since algorithms for internal optimization are simpler and execute fewer CPU instructions. Accessing data that is in memory reduces the input/output reading activity when querying the data that is normally associated with a disk-based system. This provides faster and more predictable performance than a disk-based system.

In order to utilize the advantages of an in-memory database in business, it is desirable to be able to access data stored in the in-memory database by various devices and different user interface technologies (e.g., Smartphones, tablets, HTML5 clients, etc.) using a standard protocol like hypertext transfer protocol (“HTTP”) and its variants, such as, HTTPS.

### BRIEF DESCRIPTION OF THE DRAWINGS

FIG. 1 illustrates a method according to some embodiments.

FIG. 2 illustrates a generic serialization framework according to some embodiments.

FIG. 3 illustrates a generic data provider in communication with a database according to some embodiments.

FIG. 4 illustrates a system according to some embodiments.

### DETAILED DESCRIPTION

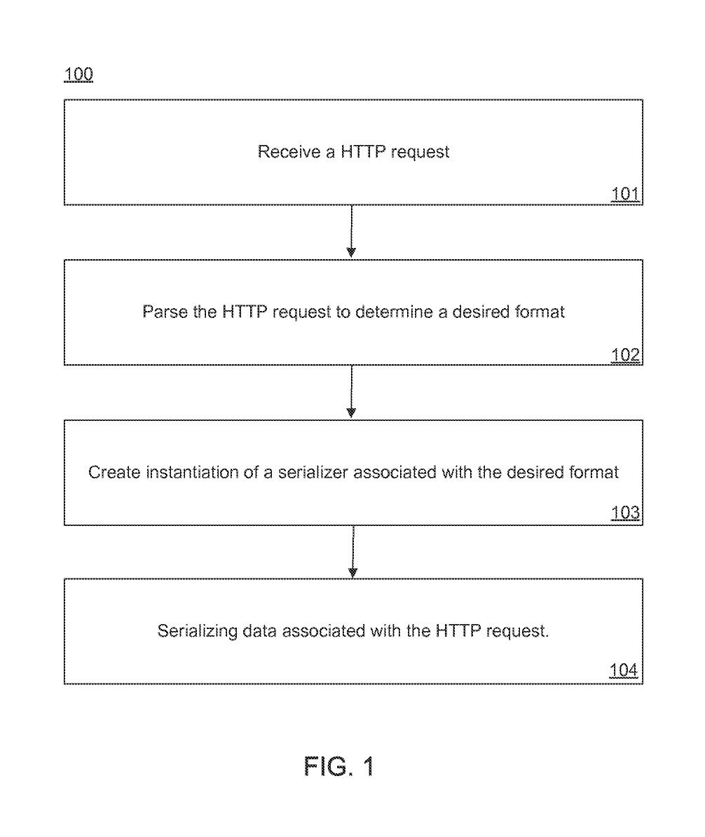

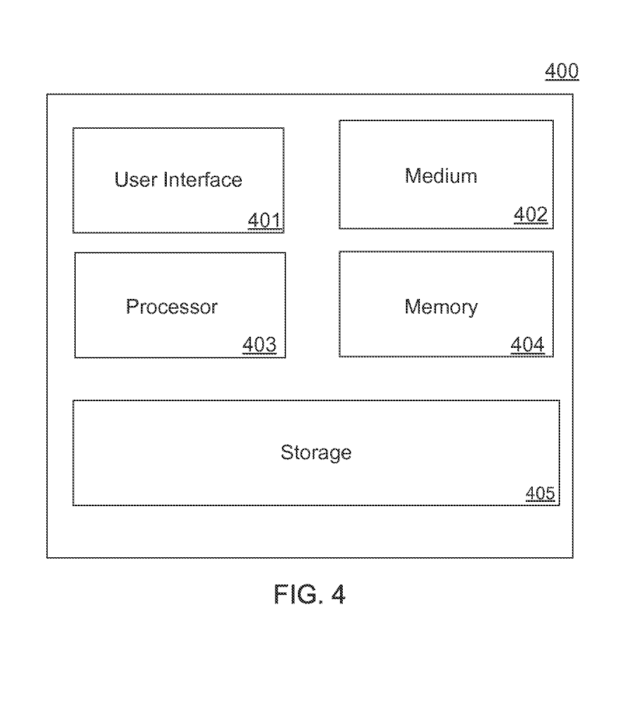

Referring now to FIG. 1, an embodiment of a method 100 is illustrated. The method 100 may be embodied on a non-transitory computer-readable medium. Furthermore, the method 100 may be performed by an apparatus such as, but not limited to, the apparatus of FIG. 4.

The method 100 may relate to extending an in-memory database in a way that stored data may be exposed as a services in various data formats by an integrated generic serialization framework over a protocol, such as, but not limited to, the HTTP protocol or the HTTP(S) protocol. The implementation of a generic serialization framework may be associated with a special database process using a fast communication (e.g., shared memory) with an in-memory database to access (e.g., read) requested data or to write specific data to the in-memory database.

The generic serialization framework may facilitate the exposure of analytical data in various data formats such as, but not limited to, AtomPub, XML, JSON, CSV, and OData, via a protocol. The exposed data may be consumed by browser-based applications or by mobile applications without a need of an additional application server. In some embodiments, the framework may be implemented in a REST-architecture where services are considered resources and CRUD-operations (e.g., create, read, update and delete) are supported on all exposed resources/services. Requested data (or data to be written) may be specified in a format as a URL parameter. Data stored in the in-memory database may be exposed as one or more services. The underlying data model of those services may be defined based on metadata describing views and tables that correspond to the service. One particular service may expose multiple views or tables as well as a combination of views and tables. A model description of a service based on the service description may be generated and acted on as soon as the service is activated. While an in-memory database is disclosed, in some embodiments, the framework may be used for disk-based databases as well.

At 101, a HTTP request is received. The HTTP request may be received at the generic serialization framework. In one embodiment, the HTTP request may be received from a database service that functions as an HTTP server. In this embodiment, the database service may comprise both the HTTP server as well as the integrated serialization framework for handling HTTP requests and for the serialization of data into a requested data format. The database service may communicate with the in-memory database via shared-memory. As stated previously, the generic serialization framework may be implemented using a REST based architecture. A REST based architecture associates each database object or service (e.g., a view, a table, etc.) as a resource. By using a REST based architecture, the components of the generic serialization framework may run as database processes communicating via shared-memory. In another embodiment, the HTTP request may be received from a conventional HTTP server such as an Apache, Tomcat, or internet information services (IIS) server. In this embodiment, the generic serialization framework may comprise a module of the conventional HTTP server and may communicate with the in-memory database via Open Database Connectivity (“ODBC”) or Java Database Connectivity (“JDBC”) for example.

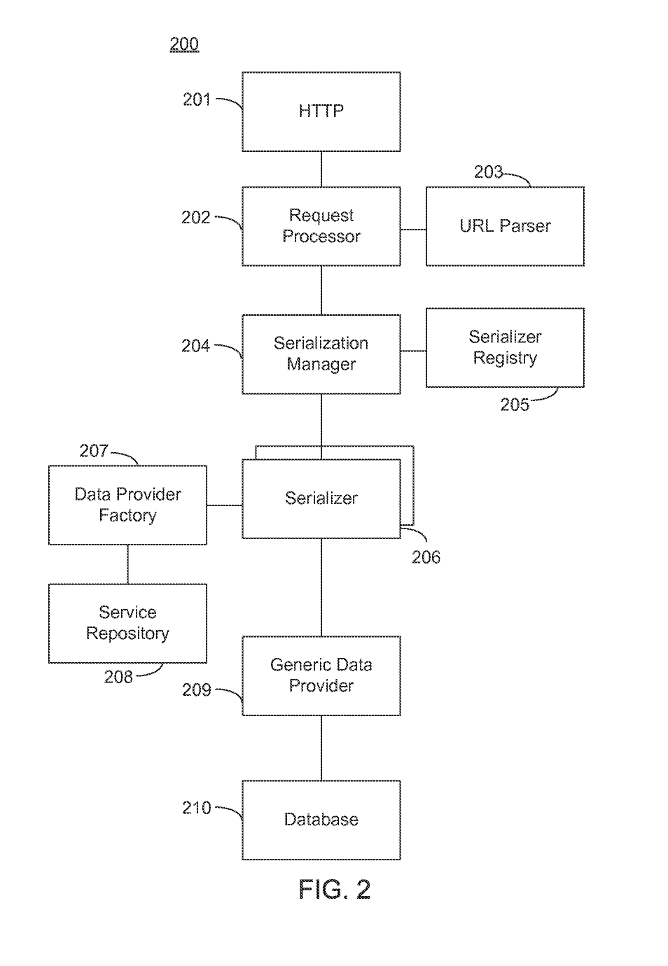

For illustrative purposes, and to aid in understanding features of the specification, an example will now be introduced. This example is not intended to limit the scope of the claims. Referring now to FIG. 2, an embodiment of a generic serialization framework 200 is illustrated. In this example, an HTTP request is received at a request processor 202 from an HTTP server 201. The request is associated with a read request (e.g., an HTTP get). However, in other embodiments, the request may be associated with a write request (e.g., an HTTP put). The example request is sent from a client (e.g., a mobile application, an HTML5 client, etc.) and send to the HTTP Server 201 which, in this example, runs on an in-memory database as part of the generic serialization framework 200. The HTTP server 201 may call an HTTP-handler to dispatch the incoming HTTP request to the request processor 202.

Referring back to FIG. 1, next, at 102, the HTTP request is parsed to determine a desired format. Continuing with the above example, the request processor 202 may determine a REST based resource (a service) that is defined by a received URL (e.g., HTTP request) which, in turn, may determine a specific view to be exposed in the in-memory database. The request processor 202, in conjunction with a URL parser 203, may parse the URL of the incoming HTTP request in order to identify a requested format for a reply to the request. The URL may also identify a requested resource (e.g., service name) and other parameters specified in the URL (e.g. format, sorting order, etc.). The request processor 202 may call a serialization manager 204 with the corresponding resource and parameters as described above.

At 103, an instantiation of a serializer associated with the desired format is created. In some embodiments, the instantiation of the serializer is created via a processor in conjunction with the serialization manager. Different instantiations of the serializer may be created based on the desired format (e.g., JSON will have a first instantiation, and XML will have a second instantiation).

Continuing with the above example and again referring to FIG. 2, a serialization manager 204 may receive the data from a request processor 202. The serialization manager 204 may perform a lookup in a serializer registry 205 to determine if a request format is supported. The serializer registry 205 may comprise information associated with a plurality of formats that may be used by the serialization manager 204 to form instantiations of a serializer. If the requested format is not supported, the serialization manager 204 may send a response to the requestor (e.g., mobile application) that the desired format is not supported. In some embodiments, the serializer registry 205 may comprise a provider that is registered for a requested service (e.g., a serializer that is implemented for a specific resource). In some embodiments, instead of a sterilizer registry 205, a generic handler which handles all requests for a particular type of database entity (e.g., views) may be used. The serialization manager 204 may instantiate a serializer 206 registered for the requested format based on the serializer registry 205.

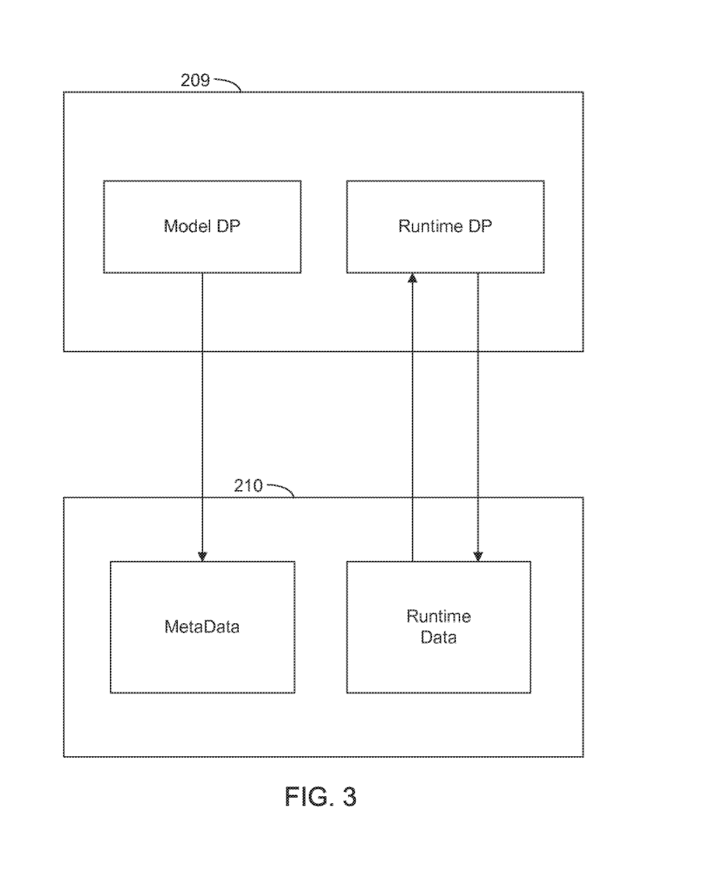

In the present example, the desired format for a standardized data-exchange is JavaScript Object Notation (“JSON”). JSON is a lightweight data-interchange format that is easy to read, to write and for machines to parse and generate. Analytical data exposed in the JSON format may be easily consumed by Javascipt based applications. For example, if the requested format is a JSON format, then the serializer 206 associated with JSON will be instantiated. However, if the requested format is XML, then the serializer 206 associated with XML will be instantiated. The instantiated serializer 206 may query the requested service data from the in-memory database by utilizing a generic data provider 209 as will be explained in further detail with reference to FIG. 3.

In another example, the requested format may be in the form of an Extensible Markup Language (“XML”). XML data sources may be configured for a commercial reporting system, such as, but not limited to Crystal Reports. XML data sources comprise of an XML schema and an XML data file. In this example, a request URL may identify both the XML schema and the XML data file in a single HTTP request. In the proposed generic serialization framework, serializers may be implemented and registered for the provisioning of a specific resource (e.g., an analytical REST based resource such as an analytical database view or calculation database view) as a Crystal Reports XML data source. This data may be requested by a Crystal Reports system (e.g., a refresh operation for the data source) via an HTTP request with a special format/parameter (e.g., http://<URL for data>?format=cr_xml and http://<URL for schema>?format=cr_xsd). In this case, a Crystal Reports system associated with an in-memory database may be created without modification of the Crystal Reports application.

At 104, data associated with the HTTP request is serialized. Serialized data may comprise data that is converted into a serial data stream. After the data is retrieved from the database, it may be converted to the requested format and then serialized. Once serialized the serialized data may be sent to the serialization manager 204. The serialization manager 204 may return a generated output to the request processor 202. The request processor 202 may create an HTTP response and set an HTTP status code and pass the results to the HTTP handler associated with the HTTP server 201. The HTTP handler via the HTTP server 201 sends the requested results to the requestor (e.g. mobile application). Once received, the requestor may process the results that were sent in the requested format. The serializer 206 may transform a result set into the requested format and perform a type conversion based on a model of the service being accessed

The serializer 206 may work in conjunction with a data provider factory 207 and a service repository 208. The data provider factory 207 may obtain information (e.g., metadata) associated with a service that is to be exposed. The metadata may, for example, indicate a data type (e.g., integer, character, floating point, etc.). Furthermore, the metadata may map a user interface to specific fields of the database.

The service repository 208 may be associated with a collection of services that may be exposed. A service may comprise a selection of data to be exposed. For example, the service may comprise, but it not limited to, a table, a view, a collection of tables, or a plurality of views.

Now referring to FIG. 3, an embodiment of a generic data provider 209 in communication with a database 210 is illustrated. The generic data provider 209 may extract the requested data from the database 210 (e.g., an in-memory database) and pass the data to the serializer 206 in an internal format (e.g. SQL rowset). The generic data provider 209 comprises a Model Data Provider (“Model DP”) and a Runtime Data provider (“Runtime DP”). The Model DP retrieves metadata from the database where the metadata relates to data types of the information being retrieved. The generic data provider 209 may use the retrieved metadata to build a service model of the requested resource and the data may be read based on this model of the requested resource. The runtime DP may act as an interface to the runtime data (e.g., views and tables) of the database 210. Both the Model DP and the Runtime DP access the database 210 using a structured query language.

Now referring to FIG. 4, an embodiment of an apparatus 400 is illustrated. The apparatus 400 may comprise a user interface 401, a main memory 402, a processor 403, a medium 404, and a storage device 405. According to some embodiments, the apparatus 400 may further comprise a digital display port, such as a port adapted to be coupled to a digital computer monitor, television, portable display screen, or the like.

The user interface 401 may allow users to interact with the apparatus 400 using text commands or with images/graphical icons. In some embodiments, the user interface may comprise a keyboard, mouse, or associated port related thereto. Furthermore, the user interface 401 may comprise a display or a touch screen.

The main memory 402 may comprise any type of memory for storing data, such as, but not limited to, a Secure Digital (SD) card, a micro SD card, a Single Data Rate Random Access Memory (SDR-RAM), a Double Data Rate Random Access Memory (DDR-RAM), or a Programmable Read Only Memory (PROM). The main memory 402 may comprise a plurality of memory modules.

The processor 403 may include or otherwise be associated with dedicated registers, stacks, queues, etc. that are used to execute program code and/or one or more of these elements may be shared there between. In some embodiments, the processor 403 may comprise an integrated circuit. In some embodiments, the processor 403 may comprise circuitry to perform a method such as, but not limited to, the method described with respect to FIG. 1.

The processor 403 communicates with the storage device 405. The storage device 405 may comprise any appropriate information storage device, including combinations of magnetic storage devices (e.g., a hard disk drive), optical storage devices, and/or semiconductor memory devices. The storage device 405 stores a program for controlling the processor 403. The processor 403 performs instructions of the program, and thereby operates in accordance with any of the embodiments described herein. For example, the processor 403 may create an instantiation of a serializer associated with a desired format.

The medium 404 may comprise any computer-readable medium that may store processor-executable instructions to be executed by the processor 403. For example, the medium 404 may comprise a non-transitory tangible medium such as, but is not limited to, a compact disk, a digital video disk, flash memory, optical storage, random access memory, read only memory, or magnetic media.

The program may be stored in a compressed, uncompiled and/or encrypted format. The program may furthermore include other program elements, such as an operating system, a database management system, and/or device drivers used by the processor 403 to interface with peripheral devices.

As used herein, information may be “received” by or “transmitted” to, for example: (i) the apparatus 400 from another device; or (ii) a software application or module within the apparatus 400 from another software application, module, or any other source.

In some embodiments, the storage device 405 stores a database (e.g., including information associated with services, formats, and metadata). However, various databases might be split or combined in accordance with any of the embodiments described herein.

The following illustrates various additional embodiments and do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Moreover, while embodiments have been illustrated using particular types of tables and databases, embodiments may be implemented in any other of a number of different ways. For example, some embodiments might be associated with publically available information, such as flight or train schedules available via web sites.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A method comprising:
receiving a HTTP request;
parsing the HTTP request to determine a desired format; and
creating, via a processor, an instantiation of a serializer associated with the desired format.

2. The method of claim 1, further comprising:
retrieving data associated with the HTTP request from an in-memory database.

3. The method of claim 1, wherein the serializer converts the requested data from the database into a serial data stream in the desired format.

4. The method of claim 1, further comprising:
determining an availability of the desired format.

5. The method of claim 1, further comprising:
retrieving data associated with the HTTP request via a generic data provider that interfaces with an in-memory database.

6. The method of claim 5, wherein the generic data provider associates database elements with a service.

7. The method of claim 1, wherein the HTTP request is received from a database service.

8. A non-transitory computer-readable medium comprising instructions that when executed by a processor perform a method, the method comprising:
receiving a HTTP request;
parsing the HTTP request to determine a desired format; and
creating, via a processor, an instantiation of a serializer associated with the desired format.

9. The medium of claim 8, the method further comprising:
retrieving data associated with the HTTP request from an in-memory database.

10. The medium of claim 8, wherein the serializer converts the requested data from the database into a serial data stream in the desired format.

11. The medium of claim 8, the method further comprising:
determining an availability of the desired format.

12. The medium of claim 8, the method further comprising:
retrieving data associated with the HTTP request via a generic data provider that interfaces with an in-memory database.

13. The medium of claim 12, wherein the generic data provider associates database elements with a service.

14. The medium of claim 8, wherein the HTTP request is received from a database service.

15. An apparatus comprising:
a processor;
a non-transitory computer-readable medium comprising instructions that when executed by the processor perform a method, the method comprising:
receiving a syntax correct query;
analyzing the syntax correct query; and
outputting a message associated with the syntax correct query.

16. The apparatus of claim 15, the method further comprising:
retrieving data associated with the HTTP request from an in-memory database.

17. The apparatus of claim 15, wherein the serializer converts the requested data from the database into a serial data stream in the desired format.

18. The apparatus of claim 15, the method further comprising:
determining an availability of the desired format.

19. The apparatus of claim 15, the method further comprising:
retrieving data associated with the HTTP request via a generic data provider that interfaces with an in-memory database.

20. The apparatus of claim 19, wherein the generic data provider associates database elements with a service.
